(19) United States
(12) Patent Application Publication
(10) Pub. No.: US 2004/0221243 A1
(43) Pub. Date: Nov. 4, 2004

(54) Radial menu interface for handheld computing device

(76) Inventors: Timothy D. Twerdahl, Los Altos, CA (US); Roger S. Flores, Redwood City, CA (US); William B. Rees, Mountain View, CA (US)

Correspondence Address: CARR & FERRELL LLP, 2200 GENG ROAD, PALO ALTO, CA, 94303, US

(21) Appl. No.: 10/826,533

(22) Filed: Apr. 16, 2004

Related U.S. Application Data
(60) Provisional application No. 60/467,164, filed on Apr. 30, 2003.

(51) Int. Cl. G09G 5/00

(52) U.S. Cl. 715/834; 715/810; 715/841

(57) ABSTRACT

A handheld device comprising a display screen, a processor, and an input device is provided. The processor is configured to present a graphical user interface comprising a radial menu including a plurality of first level menu items in a circumferential arrangement. The input device is configured to send a user input to the processor for navigating the radial menu. The graphical user interface is configured such that selecting one of the plurality of first level menu items causes a plurality of second level menu items associated with the one first level menu item to replace the first level menu items in the circumferential arrangement. The handheld device can further comprise an actuator for producing a tactile feedback, the processor being further configured to signal the actuator to produce the tactile feedback as the radial menu is navigated.

### CROSS-REFERENCE TO RELATED APPLICATIONS

This application claims the benefit of U.S. Provisional Patent Application Serial No. 60/467,164, filed Apr. 30, 2003, entitled “Radial Menu Interface for Handheld Computing Device,” which is incorporated herein by reference in its entirety.

### BACKGROUND OF THE INVENTION

1. Field of the Invention

The present invention relates generally to the field of consumer electronics and more particularly to a graphical user interface for use in a handheld computing device.

2. Description of the Prior Art

Hierarchical menus displayed on a graphical user interface (GUI), such as drop-down menus and hyperbolic trees, are well known for displaying and accessing applications and files on computing devices. Such menus, however, have been designed primarily for desktop computer systems and are not optimized for electronic devices with smaller screens.

Therefore, what is needed is a menu format for electronic devices with smaller screens that provides both ease of navigation and compactness.

### SUMMARY

The present invention provides a graphical user interface for a computing device comprising a radial menu including a plurality of first level menu items in a circumferential arrangement, for example, about a central object. The graphical user interface is configured such that selecting one of the plurality of first level menu items causes a plurality of second level menu items associated with the one first level menu item to replace the first level menu items in the circumferential arrangement. The central object can include text or an icon to represent a user operation such as replacing the radial menu with a menu in a list format or displaying the first level menu items. The plurality of first level menu items can be populated according to a default configuration, and in some embodiments, can be populated according to a user preference. The graphical user interface can further comprise a list format of menu items adjacent to the radial menu, and the graphical user interface can be further configured to allow menu items to be exchanged between the list format and the radial menu.

The present invention also provides a computing device, such as a handheld device, comprising a display screen, a processor, and an input device. The processor is configured to present a graphical user interface on the display screen, the graphical user interface comprising a radial menu including a plurality of first level menu items in a circumferential arrangement. The graphical user interface is configured such that selecting one of the plurality of first level menu items causes a plurality of second level menu items associated with the one first level menu item to replace the first level menu items in the circumferential arrangement. The input device is configured to send a user input to the processor for navigating the radial menu. In some embodiments in which the computing device is a handheld computing device, the handheld computing device further comprises an actuator for producing a tactile feedback, and the processor is further configured to signal the actuator to produce the tactile feedback as the radial menu is navigated. In some embodiments of the computing device, the input device is an analog input device comprising a two-axis joystick mechanically biased to a center position, and in some of these embodiments selection of a first or second menu item is effected by returning the joystick to the center position.

The present invention also provides a computing device comprising a handheld device, a display screen, and a processor configured to present a graphical user interface on the display screen, the graphical user interface comprising a menu, such as a radial menu. The handheld device includes an input device, such as a analog input device, configured to send a user input to the processor for navigating the menu, and an actuator for producing a tactile feedback, the processor being further configured to signal the actuator to produce the tactile feedback as the menu is navigated. In some embodiments, the handheld device includes the display screen and the processor. The tactile feedback can be a vibration. The processor can be further configured to signal the actuator to produce the tactile feedback when a menu item is selected.

### BRIEF DESCRIPTION OF DRAWINGS

FIG. 1 is a symbolic top view diagram of an exemplary handheld computing device according to an embodiment of the present invention.

FIG. 2 shows an exemplary first level radial menu presented on the display screen of the handheld computing device according to an embodiment of the present invention.

FIG. 3 shows an exemplary second level radial menu presented on the display screen of the handheld computing device according to an embodiment of the present invention.

FIG. 4 is a schematic representation of a handheld computing device including an actuator to provide tactile feedback according to an embodiment of the present invention.

### DETAILED DESCRIPTION OF THE INVENTION

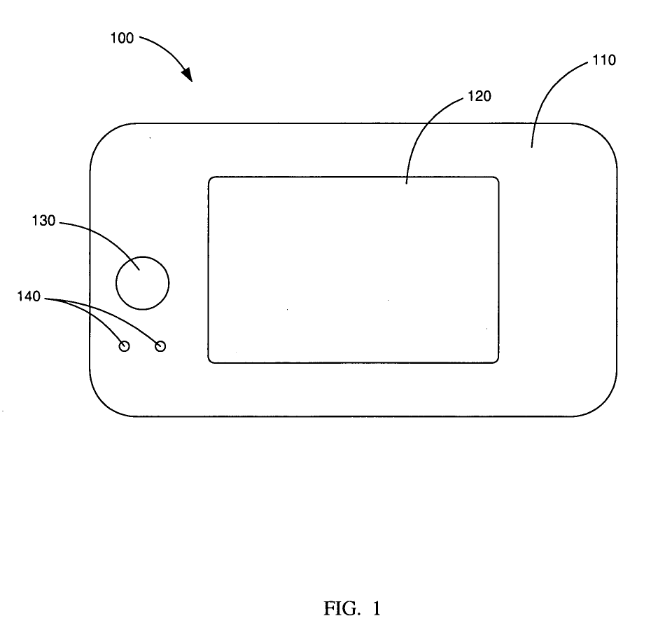

FIG. 1 is a symbolic top view diagram of an exemplary handheld computing device 100 (e.g., a personal digital assistant (PDA), a gaming device, or a cell phone) in which a graphical user interface (GUI) on which a radial menu (described in detail below) can be implemented. The handheld computing device 100 includes a housing 110 of suitable size and shape to be gripped by hands of a user. A processor and associated circuitry (not shown) disposed within the housing 110 executes instructions associated with a set of software applications. A display screen 120, secured to the housing 110, presents the GUI through which graphics and text are displayed to the user. The handheld computing device 100 can also include other well known features that have been omitted from FIG. 1 for clarity such as expansion slots to receive memory cards or sticks, interfaces for attaching peripheral devices or other electronic devices, and so forth. It will be understood that although the present invention is described with respect to a handheld device, the radial menu can be readily implemented in any computing device that includes a GUI.

User input to the processor is effected by the manipulation of one or more user controls such as an analog input device 130, a set of digital switches 140, or a touch sensitive display screen 120. The analog input device 130, for instance, can take the form of a conventional two-axis joystick mechanically biased to a center position. The function of analog input device 130 may alternatively be achieved using an eight-way digital switch.

The radial menu interface of the present invention is described herein with respect to an exemplary implementation that allows a user to select an application from a plurality of available applications. Generally, a radial menu interface consists of a set of individual radial menus logically organized in a hierarchical fashion, such that the selection of a first level menu item from a first level radial menu causes a second level radial menu to be displayed. The second level menu, in turn, includes a plurality of second level menu items associated with the selected first level menu item. Although two menu levels are described in the exemplary implementation, it will be apparent that further menu levels can be readily added. Menu items at any level in the hierarchy can be provided to cause another menu level to be displayed, to open a particular file, or to cause a particular application to execute.

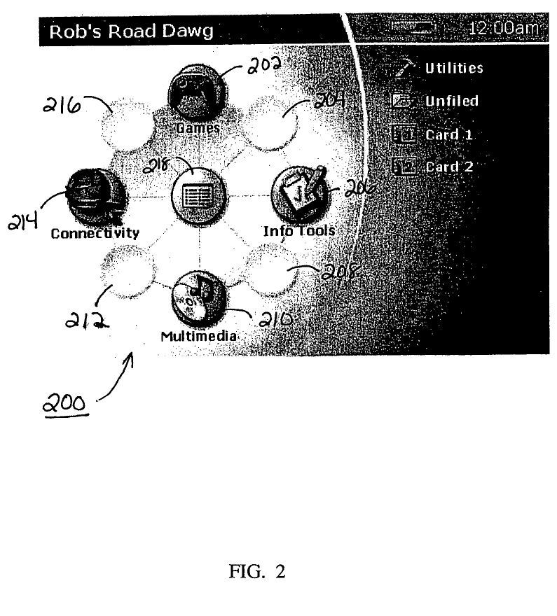

FIG. 2 depicts an exemplary first (or top) level radial menu 200 presented on the display screen 120 (FIG. 1) of the handheld computing device 100 (FIG. 1). The first level menu 200 includes a set of first level menu items 202-216 in a circumferential arrangement. In some embodiments a first central object 218 is set within the circumferential arrangement of first level menu items 202-216, preferably at the center thereof. While eight menu items are depicted, it should be recognized that a greater or lesser number of menu items can be used without departing from the scope of the present invention.

In the example shown, four of the menu items (202, 206, 210 and 214) are populated and the remaining four menu items (204, 208, 212, and 216) are empty. As used herein, a populated menu item is one that represents a link to another menu level, a file, an application, and so forth. Each populated menu item 202, 206, 210 and 214 includes text and/or a graphic icon to represent the link. In the present example the links are the following application categories: Games (202), Info Tools (206), Multimedia (210), and Connectivity (214). The first central object 218 may also include text and/or a graphic icon to represent a user operation. In FIG. 2, the first central object 218 shows, for example, an icon of a menu in list form to represent an operation of switching the first level menu 200 to a conventional list format.

The several menu items in the first level menu 200 may be populated in a number of different ways. For example, in some embodiments the first level menu 200 is arranged according to a default configuration as may be specified by a manufacturer. In preferred embodiments, the user can alter the configuration of the first level menu 200 by rearranging, adding, removing, or substituting first level menu items. These operations may be performed, for example, using a drag-and-drop or copy/paste action, or through a dialog box. As previously noted, a menu item in the first level menu 200 can represent, for example, another menu level, a file such as a MP3, a spread sheet, a text document, or an application such as a gaming program, a media player, or a web browser.

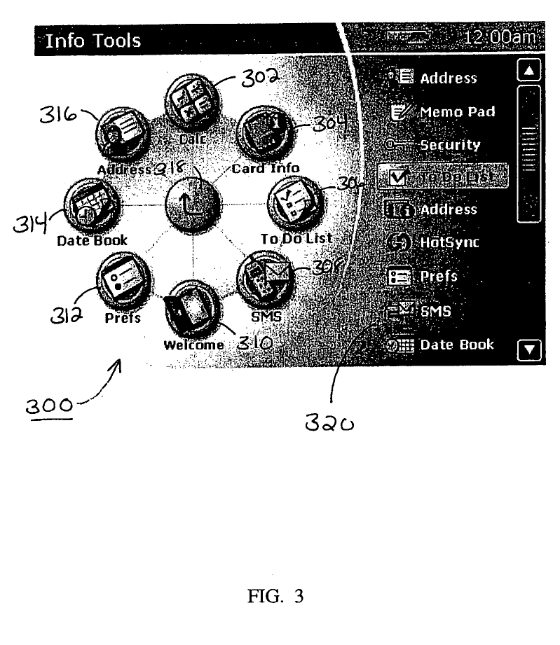

Upon selection of a first level menu item that represents a second level menu (e.g., the Info Tools menu item 206 in the present example), the second level menu is generated and displayed on the display screen 120 (FIG. 1). The second level menu comprises a plurality of second level menu items associated with the selected first level menu item, and the second level menu items replace the first level menu items in the circumferential arrangement about the central object. FIG. 3 depicts an example of a second level menu 300 displayed in response to the selection of the Info Tools menu item 206 (FIG. 2). Accordingly, the second level menu 300 includes a plurality of second level menu items 302-316 is a circumferential arrangement. Here, too, a second central object 318 can be disposed within the circumferential arrangement of second level menu items 302-316. The second central object 318 can be the same as the first central object 218, or different as shown. In FIG. 3, the second central object 318 has an “up one level” symbol and can be selected by the user to select the user operation of returning to the first level menu 200 (FIG. 2).

In the example shown in FIG. . 3, all of the second level menu items are populated. As with the first level menu 200 (FIG. 2), each second level menu item, for example, “To Do List” menu item 306, can include text and/or a graphic icon to represent an application in the selected Info Tools category. Similarly, a second level radial menu displayed upon selection of, for example, the “Games” menu item 202 (FIG. 2), would include a set of second level menu items each having text and/or a graphic icon to represent a particular game application. As noted above, second level radial menus need not be fully populated nor are they limited to applications. For example, where 12 game applications are available, a user can configure the second level radial menu to have six of the second level menu items dedicated to six favorite games, have one of the second level menu items left blank, and can have the eighth second level menu item lead to a third level radial menu for More Games that is populated with the remaining six game applications.

Selecting a menu item can be accomplished in a number of different ways. Referring again to FIG. 1, in one example, the menu item can be selected by navigating around a radial menu using the analog input device 130 until the desired menu item is highlighted. Referring now to FIG. 2 for the purposes of illustration, assume that the “Games” menu item 202 is initially highlighted, and that the user desires to select the “Info Tools” menu item 206. To do so, the analog input device 130 (FIG. 1) can be urged in a downward and rightward direction (corresponding to the position of “Info Tools” menu item 206 relative to the position of Games menu item 202). This action causes the Info Tools menu item 206 to be highlighted. The highlighted menu item is then selected by the user by releasing the analog input device 130 (which allows the analog input device 130 to return a center rest position), or by performing an equivalent action, such as by depressing one of the digital switches 140 (FIG. 1).

The digital switches 140 can also be used to navigate around the radial menus 200, 300 in some implementations. One or more of the digital switches 140 can also have a menu-specific or context-sensitive function. For example, pressing one of the digital switches 140 may cause the top level radial menu 200 to be displayed. Also, in some embodiments, the menu item can be selected by tapping on the display screen 120 on or near to the desired menu item.

It will be appreciated that a cursor, such as a mouse cursor that is directed around a GUI through the use of a mouse in a traditional computer system, can also be implemented in handheld computing devices 100 of the present invention. In these embodiments the cursor can be directed around the GUI, for example, by manipulation of the analog input device 130. Also in some of these embodiments, when the cursor passes over or near a menu item that menu item is highlighted.

It should be noted that the analog input device 130 advantageously allows the user to easily and intuitively navigate to any desired menu item in a radial menu. In one implementation of the present invention, navigation is always selectively effected in a clockwise or counterclockwise direction (depending on the direction in which the user urges the analog input device 130) around the circumference defined by the menu items, (i.e., circumferentially adjacent menu items are successively highlighted along a clockwise or counterclockwise path, and the user may not navigate through the central object). In these embodiments, an attempt to move through the center object, because the analog input device 130 returns to the center rest position, is interpreted as a selection of the last highlighted menu item. In these embodiments, selecting a user operation linked to the central object is achieved by another input device such as depressing a particular digital switch 140 or tapping on the display screen 120.

In some embodiments, the top level radial menu 200 is displayed automatically whenever the handheld computing device 100 is turned on. The handheld computing device 100 can also be configured such that an input device, such as one of the digital switches 140, can be used to toggle the top level radial menu 200 on and off. This can also be accomplished, in some embodiments, by tapping on a particular icon in the GUI on the display screen 120. Other events can also cause the top level radial menu 200 to be displayed. Such events can include inserting a memory card into an expansion slot of the handheld computing device 100, and connecting the handheld computing device 100 to another computing device, for instance, according to a wireless protocol. It will be appreciated that such events, in some instances, will cause a second level radial menu 300 to be displayed instead of the first level radial menu 200. It will also be appreciated that some events that occur while a radial menu is displayed can cause a particular menu item to be selected.

In some embodiments, navigation around a radial menu is accompanied by a tactile response. In a handheld device, such as handheld computing device 100 (FIG. 1) or a game controller for a video game system, an actuator can be provided that produces a brief vibration or jarring motion to the handheld device. Such actuators are well known in the art for purposes such as force feedback.

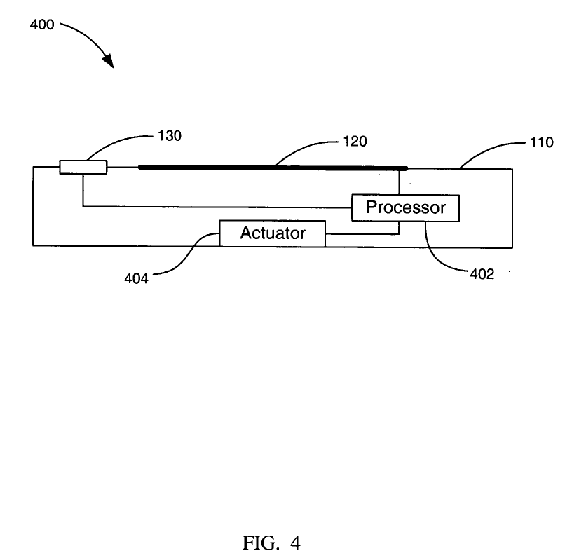

A schematic representation of a handheld computing device 400, shown in FIG. 4, illustrates an implementation of tactile response during navigation of the radial menu. The handheld computing device 400 includes a housing 110, a display screen 120, and an analog input device 130 as shown in FIG. 1. A processor 402 disposed within the housing 110 running an operating system displays a radial menu interface on the display screen 120. The processor 402 also receives user input, for example, from the analog input device 130, and highlights appropriate menu items in response thereto. As successive menu items are highlighted, for instance, the processor 402 signals an actuator 404 coupled to the housing 110 to produce a vibration or similar effect that can be felt by the user holding the handheld computing device 400.

In some embodiments, the intensity, duration, or type of tactile feedback depends on the identity of the menu items. For example, navigating to a menu item that represents a game application may be accompanied by a different type of tactile feedback than navigating to a menu item that represents an Info Tool. In some instances, navigating to certain menu items does not produce tactile feedback while navigating to other does. Also, in some instances, selecting a menu item is accompanied by tactile feedback. Likewise, selecting a user operation can be accompanied by tactile feedback. As above, the tactile feedback that accompanies the selection of a menu item or user operation can vary according to the type of menu item. For example, selecting a car game can be accompanied by a vibration that feels like an engine starting.

It is also noted that sounds can also accompany navigation through radial menus and selection of menu items and user operations. In the example above of the selection of a car game, the selection can also be accompanied by the sound of a car engine starting. Further, in addition to highlighting menu items or the central object while navigating a menu level, other visual effects can also be applied. For instance, as the user navigates through menu items, each menu item can be colored, enlarged, or animated. In some embodiments the menu items adjacent to the highlighted menu item are also enlarged or otherwise effected, but by a lesser degree than the highlighted menu item. Other visual distortions and effects can be readily applied to the GUI to follow the user navigation around the radial menu interface.

It will also be appreciated that the tactile feedback accompanying navigation of a menu is not limited to handheld devices such as the handheld computing device 100 (FIG. 1), nor is it limited to radial menus. For example, a gaming device can comprise a controller including a processor, and a handheld device including an input device and an actuator. The gaming device can display a radial menu of the present invention on a monitor or television display. The processor in the controller can be configured to receive user input from the input device to navigate the radial menu and signal the actuator to provide tactile feedback as described above. Similarly, the menu need not be a radial menu. Thus, the handheld computing device 100 (FIG. 1) as described herein, but having a prior art menu such as a drop down menu can be configured such that navigating the prior art menu is accompanied by tactile feedback.

Referring again to FIG. 3, it is noted that items, such as applications, in a radial menu can be additionally displayed in a list format 320 in an area of the display screen 120 (FIG. 1) adjacent to an area in which the radial menu 300 is displayed. For instance, a list of Info Tools applications may include certain applications that are not represented by menu items in the corresponding second level radial menu 300 (e.g., “Memo Pad”). Such applications may be added by the user to the second level radial menu 300 (either to populate empty menu items, or as substitutes for existing menu items) to suit the user's preferences using a drag-drop operation or similar action.

In the foregoing specification, the present invention is described with reference to specific embodiments thereof, but those skilled in the art will recognize that the present invention is not limited thereto. Various features and aspects of the above-described invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A graphical user interface for a computing device comprising:
a radial menu including a plurality of first level menu items in a circumferential arrangement;
the graphical user interface being configured such that a selection of one of the plurality of first level menu items causes a plurality of second level menu items associated with the one first level menu item to replace the first level menu items in the circumferential arrangement.

2. The graphical user interface of claim 1 wherein the radial menu further includes a central object disposed within the circumferential arrangement.

3. The graphical user interface of claim 2 wherein the central object includes text or an icon to represent a user operation.

4. The graphical user interface of claim 3 wherein the user operation includes replacing the radial menu with a menu in a list format.

5. The graphical user interface of claim 3 wherein the user operation includes displaying the first level menu items.

6. The graphical user interface of claim 1 wherein the plurality of first level menu items are populated according to a default configuration.

7. The graphical user interface of claim 1 wherein the plurality of first level menu items can be populated according to a user preference.

8. The graphical user interface of claim 1 further comprising a list format of menu items adjacent to the radial menu.

9. The graphical user interface of claim 7 wherein the graphical user interface is further configured to allow menu items to be exchanged between the list format and the radial menu.

10. The graphical user interface of claim 1 wherein at least one of the plurality of first level menu items includes text or an icon to represent a link to another menu level.

11. The graphical user interface of claim 1 wherein at least one of the plurality of second level menu items includes text or an icon to represent a link to an application.

12. A computing device comprising:
a display screen;
a processor configured to present a graphical user interface on the display screen,
the graphical user interface comprising
a radial menu including a plurality of first level menu items in a circumferential arrangement;
the graphical user interface being configured such that a selection of one of the plurality of first level menu items causes a plurality of second level menu items associated with the one first level menu item to replace the first level menu items in the circumferential arrangement; and
an input device configured to send a user input to the processor for navigating the radial menu.

13. The computing device of claim 12 wherein the computing device is a handheld device.

14. The computing device of claim 12 further comprising an actuator for producing a tactile feedback, the processor being further configured to signal the actuator to produce the tactile feedback as the radial menu is navigated.

15. The computing device of claim 12 wherein the input device is an analog input device comprising a two-axis joystick mechanically biased to a center position.

16. The computing device of claim 15 wherein selection of a first or second menu item is effected by returning the joystick to the center position.

17. A computing device comprising:
a display screen;
a processor configured to present a graphical user interface on the display screen, the graphical user interface comprising a menu; and
a handheld device including
an input device configured to send a user input to the processor for navigating the menu, and
an actuator for producing a tactile feedback, the processor being further configured to signal the actuator to produce the tactile feedback as the menu is navigated.

18. The computing device of claim 17 wherein the handheld device further includes the display screen and the processor.

19. The computing device of claim 17 wherein the menu is a radial menu.

20. The computing device of claim 17 wherein the tactile feedback is a vibration.

21. The computing device of claim 17 wherein the input device is an analog input device.

22. The computing device of claim 17 wherein the processor is further configured to signal the actuator to produce the tactile feedback when a menu item is selected.

23. The computing device of claim 17 further configured to produce a sound when the actuator is signaled to produce the tactile feedback.
